(19) United States
(12) Patent Application Publication
(10) Pub. No.: US 2010/0216357 A1
(43) Pub. Date: Aug. 26, 2010

(54) STABILISATION FOR WATERCRAFT

(75) Inventors: Hilary Eric Hanslow, Ballina (AU); Elizabeth Margaret Hanslow, Ballina (AU)

Correspondence Address: DARBY & DARBY P.C., P.O. BOX 770, Church Street Station, New York, NY, 10008-0770, US

(73) Assignee: BRINGABOATALONG PTY LTD, Ballina (AU)

(21) Appl. No.: 12/671,182

(22) PCT Filed: Jul. 28, 2008
(86) PCT No.: PCT/AU2008/001089

§ 371 Date: Jan. 28, 2010

(30) Foreign Application Priority Data
Jul. 30, 2007 (AU) 2007904089
Jun. 27, 2008 (AU) 2008903287

(51) Int. Cl. B60F 3/00; B63B 1/10; A47C 1/02; A47C 1/032; E03C 1/32; E03D 5/00; A47K 3/02; A47K 3/28

(52) U.S. Cl. 440/12.5; 114/61.15; 297/311; 297/341; 114/363; 4/643; 4/300; 4/538; 4/612

(57) ABSTRACT

A watercraft having a main hull and at least one deployable outrigger pontoon moveable between a stored condition in which the at least one outrigger pontoon is located adjacent the main hull, and a use condition in which the at least one outrigger pontoon is located spaced from the main hull to increase at least one footprint dimension of the watercraft at the waterline, the at least one deployable outrigger pontoon moving at least partially outwardly and downwardly during deployment.

### FIELD OF THE INVENTION

The present invention relates to movement and stability of watercraft in general and particularly a dual use vehicle operable as a watercraft and land vehicle.

### BACKGROUND ART

Amphibious vehicles are known as are watercraft with external stabilization means such as “outrigger” pontoons.

U.S. Pat. No. 6,840,825 to Messano provides an amphibious recreational vehicle. Indeed, inventor Messano has been active in this area having at least three other granted patents which are directed to mechanisms or devices adapted to be used with an amphibious vehicle.

U.S. Pat. No. 6,840,825 however describes an amphibious recreational vehicle comprising:
a rooftop fold-down flying bridge deck consisting of a bulwarks on multiple sides of the roof top,
a plurality of fold-down safety rails on multiple sides of the rooftop, and
a plurality of fold-down seating affixed to the rooftop;
a rooftop steering station within the rooftop fold-down flying bridge deck;
a cabin below the rooftop fold-down flying bridge deck;
an expandable width watertight hull below the cabin which consists of outer-hulls hinged to a central hull, when expanded, forms a one-piece wide-beam modified cathedral planing hull comprising:
a central hull;
an outer-hull on each longitudinal side of the central hull;
a plurality of planing surfaces on the hulls;
a plurality of land travel wheels within the outer-hulls;
a hinge mechanism coupling the outer-hulls as to be pivotally positioned under the central hull for land travel, and positioned adjacent to the central hull for water travel while also raising the land travel wheels out of the water;
a powered actuator to pivot the hulls between the land travel and water travel positions where the powered actuator is fully above the waterline for water travel;
a ground effects lifting tunnel between the hulls; and
a provision for marine propulsion

It can be seen from this patent that the Messano device is complex with many moving parts. It can also be seen that the bottom of the vehicle expands outwardly and upwardly in the transformation from a land vehicle to a marine vessel.

The present invention is therefore directed to providing an improvement which may at least partially overcome at least one of the abovementioned disadvantages or provide the consumer with a useful or commercial choice.

Reclining seating has long been used for armchairs, or in vehicles such as cars and aeroplanes. The aim of reclining seating is to allow a user to adjust the angle of the backrest of their seat to improve the comfort of the seat, or to allow a user to adopt a more horizontal position if the user wishes to sleep.

In order to be able to function successfully, existing reclining seating has a back which reclines. Thus, existing reclining seating (such as that disclosed by U.S. Pat. No. 3,844,608, the disclosure of which is hereby incorporated by reference) must be placed in locations in which there is sufficient room behind the seating to accommodate the reclined seat back. Thus, existing reclining seating is unsuitable in locations where there is limited space, or where the seating has a fixed frame.

Thus there would be an advantage if it were possible to provide a reclining seating arrangement for locations with restricted space availability, such as small rooms, caravans, mobile homes, boats or the like.

In wet areas (such as bathrooms, kitchens, laundries and the like) fixtures such as sinks and basins are typically fixedly attached to a wall or floor. While this arrangement works well in large wet areas, in smaller wet areas (such as small rooms, caravans, mobile homes, boats or the like) fixtures that are permanently attached to a surface (such as a floor or wall) can lead to a small area either becoming very cluttered, or certain fixtures not being provided in a small area due to the space restrictions.

Some attempts have been made to overcome this problem. For instance, U.S. Pat. No. 6,820,290, the disclosure of which is hereby incorporated by reference, discloses movable bathroom fixtures that are mounted to a panel which is adapted to slide along rails mounted to the wall of a bathroom. However, the device disclosed by this document suffers from a number of drawbacks, including that significant additional plumbing is required to enable the fixtures to be moved to, and used in, different positions.

Thus, there would be an advantage if it were possible to provide moveable fixtures for wet areas that enable a user to move the fixtures when additional space is required.

It will be clearly understood that, if a prior art publication is referred to herein, this reference does not constitute an admission that the publication forms part of the common general knowledge in the art in Australia or in any other country.

Throughout this specification, the term “comprising” and its grammatical equivalents shall be taken to have an inclusive meaning unless the context of use indicates otherwise.

### OBJECT OF THE INVENTION

It is an object of the present invention to provide a watercraft which may overcome at least some of the abovementioned disadvantages, or provide a useful or commercial choice.

With the foregoing in view, the present invention in one form, resides broadly in a watercraft having a main hull and at least one deployable outrigger pontoon moveable between a stored condition in which the at least one outrigger pontoon is located adjacent the main hull, and a use condition in which the at least one outrigger pontoon is located spaced from the main hull to increase at least one footprint dimension of the watercraft at the waterline, the at least one deployable outrigger pontoon moving at least partially outwardly and downwardly during deployment.

In a preferred embodiment, the present invention employs a significant number of production vehicle and marine components to facilitate and expedite the assembly thereof. For example, the engine and transmission of a production vehicle, including the electronics, throttle and transmission control systems, engine cooling and fuel systems may be employed in the present invention. Similarly, the safety-related components, such as the headlights, taillights, turn indicators, windshield wiper systems, and bumper impact absorbers, may also be utilized in the present invention. To this end, the present invention contemplates a vehicle which may be fully certified and approved for on-road travel.

In that embodiment, the vehicle/watercraft is limited in size, particularly width in order to be a fully certified and approved road vehicle. As can be appreciated, width has a material effect on the stability of a watercraft when afloat. All other factors being equal, a wider footprint for a watercraft creates a more stable platform. The practical effect of this, particularly when addressing a recreational watercraft such as a houseboat, is that creation of a more stable watercraft results in a more useable and safe watercraft.

In the particular case of a watercraft which is adapted to be used as a houseboat/caravan, as the vehicle should be fully certified and approved for on-road travel, there is a maximum width limit for the vehicle. Given this limit, there are restrictions on the height of the watercraft, and also the height below which a user may safely operate the watercraft. For example, it is only permitted for a user to use, that is stand, on the main deck and use of the roof (or second storey deck) is not permitted on a conventional vehicle-width watercraft.

The present invention is therefore adapted to providing a wider (or longer) footprint in order to enable legal use of an upper deck. This enhanced use would increase the value of a watercraft and also the uses to which such a watercraft can be put.

The invention resides in a watercraft. The watercraft may be of any type although the preferred embodiment is a houseboat and more particularly an houseboat/caravan. Preferably the houseboat is adapted for use as a houseboat when afloat, and when removed from the water and loaded onto a suitable trailer or similar, the houseboat can be used in a manner similar to a conventional caravan. Alternatively, the watercraft may be a mobile home, campervan or the like.

The preferred embodiment of the present invention is particularly well adapted such that in use, with the deployable pontoons in the use condition, more of any upper deck(s) can be used without destablising the vessel, making it prone to capsizing than unstabilised watercraft.

The watercraft of the present invention also has a main hull. The main hull will normally be a central or conventional hull. Multi-hulled vessels are known and the watercraft of the present invention with a pair of pontoons in the use condition will be similar in concept to a trimaran vessel with a central hull and a pair of outrigger pontoon hulls.

Trimarans have a number of advantages over comparable monohulls (conventional, single-hulled sailboats). Given two boats of the same length, the trimaran has a shallower draft, a wider beam, less hull area, and is able to fly more sail area. In addition, because of the wide beam, trimarans do not need the weighted keel required in monohulls. As a result, the trimaran offers much better straight-line performance than a monohull, is able to sail in shallower water, and maintains its stability in stronger winds. However, its wider beam makes it a little more cumbersome to maneuver, so tacking and jibing can be trickier, and the narrower hulls provide less living space than an equivalently-sized monohull.

The main hull will preferably be sufficiently buoyant to support the watercraft without the deployment of the deployable pontoons.

In an alternative embodiment, the water craft may be provided with a pair of buoyant support hulls or pontoons located at a lower portion of the craft. Each deployable outrigger pontoon may have an associated buoyant support hull or pontoon. Where provided in this configuration, each of the buoyant support hulls or pontoons will preferably be spaced from the longitudinal mid-line of the craft and extend substantially the length of the craft.

The watercraft of the invention is provided with at least one deployable outrigger pontoon moveable between a stored condition in which the at least one outrigger pontoon is located adjacent the main hull, and a use condition in which the at least one outrigger pontoon is located spaced from the main hull to increase at least one footprint dimension of the watercraft at the waterline, the at least one deployable outrigger pontoon moveable moving at least partially outwardly and downwardly during deployment.

Normally, a pair of deployable pontoons are provided on opposed lateral sides of the watercraft. The pair of pontoons are also normally mounted to be directly opposite each other with respect to the main hull.

Each of the pontoons is usually mounted at or adjacent the waterline of the watercraft.

The pontoons will usually be deployed when the watercraft is moored or anchored, but may be deployed whenever an upper or top deck is in use, even when the watercraft is underway.

The pontoons will typically be attached to the main hull in any manner so as to be pivotable or moveable between the stored and use conditions. There may be a plurality of use conditions between a fully stored conditions and a fully extended use condition.

The pontoons are normally attached relative to, and preferably directly to the main hull using a plurality of arm members attached to both the main hull and the respective pontoon.

Each pontoon is normally shorter than the overall length of the main hull.

The pontoons are preferably moveable using any means such as manually, or powered movement. When powered movement is used, it is preferred that hydraulically powered or actuated means, such as ram(s) are provided as the method of movement. Other methods may be used such as air rams or cables for example.

Limit stops may be provided to prevent movement of the arm members and/or pontoons outside of the range of the predetermined usage. There may be one or more cables, for example, linking an end portion of a pontoon to the main hull to limit the range of motion, or other means such as abutment stops to engage the arm members.

The arm members may be moved from parallel to a main axis of a hull in the storage condition, to approximately perpendicular to the main axis of a hull in the use condition. The arm members may be hollow or solid. Preferably, each arm member may be at least partially hollow to allow utilities such as power and hydraulics to extend through the arm members between the main hull and the pontoons. The arm members may be parallel to the water surface in the use and/or storage condition.

In the stored condition, it is preferable that the pontoons are received within the defined width of the vehicle used to transport the watercraft, for example, the trailer.

The pontoons may be of any shape, but normally they will be at least partially streamlined if to be used when underway. As stated previously however, the pontoons will preferably only be provided for use when the watercraft is moored and on this basis, the preferred shape may be cylindrical or any other shape.

Cushion means may be provided between the pontoons and the main hull to prevent or at least minimise damage to either component when the pontoons are moved into the stored condition.

The pontoons will preferably move both outwardly and downwardly during deployment. Preferably, the deployment of the pontoons moves them to an angle of approximately 5 to 15 degrees of downward angle, and more particularly to between 5 and 10 degrees. As an example, if the arm members are approximately 900 mm in length and the downward angle used is 5 degrees, the pontoon will be approximately 100 mm below the waterline of the main hull. This adds to stability to have the pontoons forced downward into the water below the waterline of the main hull.

The pontoons typically have an elongate, hollow configuration, each pontoon having at least one internal compartment and normally more than one. The compartments may be formed by dividing a unitary tubular member with dividers or a plurality of compartments joined to one another.

Each pontoon will preferably have a constant cross-section with a shaped bow section.

The majority of the length of each pontoon is typically empty, however, at least one ballast compartment may be provided. The ballast used will preferably be water, and it is particularly preferred that the ballast tanks contain potable water.

A portion of at least one pontoon may also store used water for recycling or the like. There may be one or more pumps provided to move the ballast water or greywater into and out of the compartments in the pontoons.

There may be a portion in each pontoon shaped to allow for the raised wheel covers on the trailer if used. If desirable, the amount of air or water may be adjustable in each compartment of each pontoon.

According to another aspect, the invention resides in a deployable basin system associated with a liquid supply tap and a liquid drain for use in confined areas, the deployable basin system including a basin adapted to at least temporarily contain liquid and including an outlet therefrom, the basin mounted relative to a support from which the liquid supply tap extends, a mounting means to mount the basin relative to the support and allow the basin to move between a use condition in which the basin is located at least partially beneath the liquid supply tap and the outlet from the basin is in fluid communication with the liquid drain, and a non-use condition wherein the basin is moved away from the liquid supply tap.

The deployable basin of the present invention is particularly well adapted for use in caravans, boats or other craft where space is limited, and particularly in the bathrooms of such craft. It requires space to have a conventional fixed basin in a bathroom of such a craft, particularly as the bathroom will contain a toilet and a shower cubicle as well. Provision of a deployable basin allows the basin to be moved into a less conspicuous position when not in use and deployed as desired.

Normally, the liquid supply tap will be mounted on or through a wall and the basin will be mounted relative to the wall in a slidable manner. Preferably, a rail or similar will be mounted relative to the wall and parallel to the wall. The basin will then preferably be mounted to slide along the rail between the use and non-use condition.

The outlet of the basin may be more or less permanently connected to the liquid drain using a flexible pipe or hose member for example. According to an alternative embodiment, the liquid drain may be configured as an upstand pipe with an upper opening and the outlet of the basin may be a downcomer with a lower opening, movement of the basin to the use condition aligning the downcomer and the upstand openings to allow flow through the outlet into the drain.

There may be a locking mechanism to releasably lock the basin in the use and/or non-use condition. Such locking mechanism may for example be a clamping mechanism that locks the basin to the rail to prevent sliding, until released. Preferably the locking mechanism is biased into the locked condition with disengagement required before movement of the basin is possible.

In another aspect, the invention resides broadly in a fixture adapted to be mounted relative to a wall, the fixture having at least one inlet and at least one outlet wherein the at least one outlet is adapted for removable alignment with at least one waste removal device, the fixture further comprising mounting means adapted to allow the fixture to be mounted on, and movable relative to, the wall between a first position in which the at least one outlet of the fixture is substantially in alignment with the at least one waste removal device such that any fluid passes through the at least one outlet enters the at least one waste removal device, and a second position in which the at least one outlet and the at least one waste removal device are not in alignment with one another.

The fixture of the present invention provides a number of significant advantages over existing devices. For instance, the fixture of the present invention allows a user to move a fixture out of the way in a confined space, meaning that a small space may be more effectively utilized. In addition, as the fixture is not rigidly connected to any plumbing fittings (water pipes, taps and the like) the fixture is simple to install and use without requiring a great deal of additional infrastructure.

The fixture may be of any suitable type. Preferably, however, the fixture is of the type used in a wet area, such as a kitchen, bathroom or laundry. Thus, the fixture may be a sink, basin, toilet, shower, bath, trough or the like.

In a preferred embodiment of the invention, the at least one inlet and the at least one outlet are in fluid communication with one another via one or more fluid pathways that pass through the fixture. The one or more fluid pathways may be of any suitable configuration, provided that any fluid (for instance, water) that enters the fixture through the inlet flows along the fluid pathway to the outlet. Fluid entering the inlet of the fixture may come from any suitable source. For instance, the fixture may be positioned below one or more taps, valves, spouts or the like, or any suitable combination thereof.

Although the fixture of the invention has been described as being mounted relative to a wall, the skilled addressee will understand that the fixture may also be mounted relative to a floor, ceiling or the like. The fixture may be mounted either directly to a wall, or may be mounted to one or more intermediate mounting devices, or may be mounted to both the wall and one or more mounting devices. In embodiments of the invention in which one or more mounting devices are present, the one or more mounting devices may be adapted for mounting to the wall. The one or more mounting devices may be either rigidly fixed to the wall (in which case the fixture is movable relative to both the support and the mounting device) or may be movable relative to the wall (in which case the fixture may be either movable relative to the wall only or to both the wall and the mounting device).

The one or more mounting devices may be of any suitable type, although it is preferred that the one or more mounting devices may be adapted to connection to both the wall and the fixture. The one or more mounting devices may comprise runners, channels, brackets or any other suitable form. In a preferred embodiment of the invention, the mounting devices comprise one or more rails. In this embodiment of the invention, the one or more rails may be permanently or temporarily attached to a wall, and the fixture may be adapted for movement relative to the fixed one or more rails. In a most preferred embodiment of the invention, a pair of rails may be provided to which the fixture may be mounted.

Any suitable mounting means may be provided on the fixture to allow the fixture to be mounted on the wall or one or more mounting devices. For instance, the fixture may be attached to the wall and/or mounting device using fasteners such as nails, screws, rivets, bolts, adhesives or the like. Alternatively, the fixture may be provided with one or more projections (such as hooks, lands, shoulders or the like) adapted for temporary or permanent engagement with the wall and/or mounting devices. In some embodiments of the invention, the fixture may be formed integrally with the mounting devices and the mounting devices may be adapted for movement relative to the wall.

In one preferred embodiment of the invention, the fixture may be provided with mounting means in the form of one or more holes, apertures or recesses into which the one or more mounting devices may enter and be retained. In this embodiment of the invention, it is preferred that the fixture may not be disengaged from the mounting devices unless the mounting devices are first disengaged from the wall.

The movement of the fixture relative to the wall and/or the one or more mounting devices may be achieved using any suitable technique. For instance, the movement may be achieved by sliding, rolling, swiveling, pivoting, a telescoping action or the like, or any combination thereof. The actuation of the relative movement of the fixture may be achieved using any suitable method, such as manually moving the fixture relative to the wall and/or the one or more mounting devices, creating the movement hydraulically or pneumatically, or the like. In embodiments of the invention in which actuation of the movement of the fixture is not manual, actuation of the movement may be achieved by pressing a button, flipping a switch, pressing a lever, by using a remote control or the like.

As previously mentioned, the at least one outlet of the fixture is adapted for removable engagement with at least one waste removal device. The waste removal device may be of any suitable type, such as, but not limited to, a pipe, conduit, drain, floor waste or the like, or any combination thereof.

In a preferred embodiment of the invention, the waste removal device may be fixedly attached to a support (such as a floor, wall, ceiling or the like). Thus, when the fixture is in its first position, the one or more outlets may be aligned with the one or more waste removal devices such that any fluid that exits the fixture through the outlet will pass into the waste removal device. However, when the fixture is moved relative to the support (i.e. between its first and second position), the one or more waste removal devices will remain stationary and the one or more outlets will no longer align with the one or more waste removal devices.

In some embodiment of the invention, the outlet of the fixture may simply align with the inlet of the waste removal device when the fixture is in the home position. In other embodiments, the inlet of the waste removal device may be provided with means (such as a funnel, cup or the like) to ensure that any fluid exiting the outlet of the fixture is collected by the waste removal device.

Alternatively, the outlet of the fixture and the inlet of the waste removal device may be adapted to engage one another when the fixture is in the home position. For instance, the outlet and/or the waste removal device may be provided with complimentary screw threaded portions, collars, telescopic or extendable portions or the like to enable their removable engagement.

In one aspect, the invention resides broadly in a reclining seat comprising a frame, a seating portion comprising at least a base and a back, the seating portion being in abutment with the frame and adapted for relative movement thereto, the reclining seat further comprising means to enhance the relative movement of the frame and the seating portion, and wherein no part of the seating portion moves further rearwardly when the reclining seat is in a reclined condition than when the reclining seat is in an upright condition.

The reclining seat of the present invention has a number of advantages over existing devices. For instance, the reclining seat of the present invention allows a user to recline their seat (for comfort, or to move the seat closer to another object, such as a table) even though the seat is located in a relatively confined area. In addition, the reclining mechanism is relatively simple, meaning that the likelihood of failure of the mechanism is less, which in turn results in a reduced requirement for maintenance.

The reclining seat may be of any suitable type. For instance, the reclining seat may be a single seat (such as an armchair) or may be a lounge, couch or sofa comprising a plurality of seats. The reclining seat may be free-standing or may be adapted for temporary or permanent attachment to a wall, floor or the like.

Any suitable frame may be used for the present invention. For instance, the frame may be constructed from wood, plastic, metal, or any combination thereof. The frame may be of any suitable size, depending on the type of reclining seat for which it is being used. The frame may be constructed as a unitary frame or may be constructed from a plurality of individual members permanently or temporarily connected to one another. In its simplest form, the frame may comprise a base portion, although the frame may also comprise further portions such as, but not limited to, a back portion, one or more legs and/or one or more armrests.

In a preferred embodiment of the invention, the frame may be a fixed or rigid frame. Thus, in this preferred embodiment of the invention, the seating portion of the reclining seat is adapted for movement relative to the stationary frame.

The relative movement of the frame and the seating portion may be achieved using any suitable technique. In some embodiments of the invention, the reclining seat may be provided with actuation means (such as a lever or button) in order to manually activate the relative movement. In another embodiment of the invention, a remote control may be provided. Alternatively, the relative movement of the seating portion and the frame may be achieved by a user manually adjusting the position of the seating portion, either by using their hands, or by shifting their weight when sitting on the reclining seat.

In some embodiments of the invention, the frame may comprise one or more further portions adapted to support the body of a user. The one or more portions may comprise headrests, armrests, leg rests or the like. In a preferred embodiment of the invention, these portions may be adapted to be temporarily or permanently attached to the frame independently of the seating portion. Thus, when the seating portion and the frame move relative to one another, the one or more further portions may remain in place on the frame.

The seating portion may be of any suitable construction, shape, size or configuration. For instance, when the frame is for a single seat, it is preferred that the seating portion is also for a single seat. However, when the frame is for a couch comprising a plurality of seats, a single seating portion comprising said plurality of seats may be used, or one or more separate seating portions, each comprising one or more seats may be used.

The seating portion may be constructed from plastic, metal, wood or the like, or any combination thereof. In some embodiments of the invention, the seating portion may be at least partially constructed from a padded or relatively compressible material, such as a foamed material, rubber, cloth or the like. Preferably, the portion of the seating portion constructed from a padded or relatively compressible material is at least that portion of the seating portion that comes into direct contact with a user's body.

Preferably, the seating portion comprises a base which, in use, rests on the base portion of the frame and is adapted to support a user's backside and thighs. The seating portion may further comprise a back adapted to rest (when the reclining seat is in an upright condition) against a back portion of the frame in the, a wall or the like which, in use, supports a user's back. In this upright condition, the base and the back may be positioned substantially perpendicular to one another. Suitably, the seating portion may further comprise one or more armrests, leg rests, headrests, or any combination thereof.

In embodiments of the invention in which a back is present, it is preferred that the back of the seating portion and the base of the seating portion are in communication with one another, such that movement of either one of the base or the back causes movement of the other.

In some embodiments of the invention, the back and the base may be formed as a single unit, or they may be formed as separate pieces and connected to one another. In this embodiment of the invention, the base and the back may be connected to one another using connection means. Any suitable connection means may be used, although it is preferred that the connection means is suitable to allow the base and back to transition between being substantially perpendicular to one another (i.e. when the reclining seat is in the upright position) to being substantially parallel to one another (i.e. when the reclining seat is in the reclined position). Thus, in a preferred embodiment of the invention, the connection means may comprise one or more hinges. Preferably, the one or more hinges are connected to a forward side of both the base and the back. The one or more hinges may also allow for pivoting of the base, so that the base may be lifted clear of the base portion of the frame for cleaning, maintenance or to gain access to, for instance, storage space located underneath the reclining seat. In some embodiments of the invention, padding, cushioning or the like may be placed over the connection means such that the user's body does not come into direct contact with the connection means.

Preferably, as the reclining seat transitions between the upright and the reclined condition, the base of the seating portion moves in a substantially horizontal direction. Preferably, the base of the seating portion moves towards the front of the reclining seat as the reclining seat moves from the upright condition to the reclined condition, and towards the rear of the reclining seat as the reclining seat moves from the reclined condition to the upright condition.

As the reclining seat transitions between the upright condition and the reclined condition, it is preferred that the angle between the back of the seating portion and the horizontal decreases. However, it is preferred that, as the reclining seat transitions between the upright and reclined conditions, the uppermost portion of the back of the seating portion is in substantially continuous abutment with the back section of the frame.

In a preferred embodiment of the invention in which the frame is rigid, the reclining action of the reclining seat is provided entirely by the reclining motion of the seating portion. Thus, the seating portion moves generally towards the front of the reclining seat as the reclining seat transitions between an upright condition and a reclined condition in such a manner that no part of the seating portion moves further rearwardly when the reclining seat is in the reclined condition compared to when the reclining seat is in the upright condition.

In some embodiments of the invention, the reverse side of the base and/or back may be provided with a backing. The backing may be constructed from any suitable material, such as, but not limited to, wood, plastic or metal. The backing may be permanently or temporarily attached to the reverse side of the base/and or back. In a preferred embodiment of the invention, the backing may be constructed so as to be rigid or semi-rigid so as to prevent the seating portion from bending or breaking during use, particularly if the seating portion is constructed from a soft or flexible material.

The means to enhance the relative movement of the frame and the seating portion may be of any suitable form. Preferably, the means is adapted for engagement with at least one of the frame and the seating portion. More preferably, the means is adapted for engagement with both the frame and the seating portion simultaneously. Any suitable engagement may be utilized, although it is preferred that the means is adapted to produce rolling or sliding relative movement between the frame and the seating portion. Thus, the means may comprise one or more rollers, slides, telescoping sections, endless tracks or the like or any combination thereof.

In some embodiments of the invention, the means may be connected to either or both of the seating portion and the frame. In an alternative embodiment of the invention, the means may comprise a separate component that is connected to neither the seating portion nor the frame.

In a most preferred embodiment of the invention, the means may be connected to the seating portion. In this embodiment of the invention, the frame may be provided with complementary receiving means along which the means may move, such as one or more bearings, channels, grooves, rails or the like.

The reclining seat may further be provided with a movement limiting device. The movement limiting device may be adapted to prevent the movement of the seating portion relative to the frame beyond a pre-determined point. In this way, the seating portion may be prevented from sliding or rolling entirely off the frame of the reclining seat. Any suitable movement limiting device may be used, such as one or more stops, limit switches, barriers or the like. In a preferred embodiment of the invention, the frame may be provided with one or more retainers which engage with the means for enhancing the relative movement of the frame and the seating portion when the seating portion reaches the extended position, thereby preventing any further movement, with the exception of movement returning the reclining seat to the contracted position.

The reclining seat of the present invention may be used in any suitable application. Preferably, however, the reclining seat may be used in applications with limited space availability, such as small rooms, caravans, mobile homes, boats or the like.

### BRIEF DESCRIPTION OF THE DRAWINGS

An embodiment of the invention will be described with reference to the following drawings in which:

FIG. 1 is a schematic view from above of a lower portion of a watercraft according to a preferred embodiment of the present invention with deployable pontoons in the stored condition;

FIG. 2 is a schematic view from the side of a lower portion of a watercraft according to a preferred embodiment of the present invention with deployable pontoons in the use condition;

FIG. 3 is a schematic view from above of a lower portion of a watercraft according to a preferred embodiment of the present invention with deployable pontoons in the use condition;

FIG. 4 is a schematic sectional view of a deployable pontoon according to a preferred embodiment of the present invention;

FIG. 5 illustrates a pair of reclining seats according to an embodiment of the present invention;

FIG. 6 illustrates a reclining seat according to an embodiment of the present invention;

FIG. 7 illustrates a reclining seat according to an embodiment of the present invention;

FIG. 8 illustrates a fixture according to an embodiment of the present invention;

FIG. 9 illustrates a fixture according to an embodiment of the present invention;

FIG. 10 illustrates a side view of a fixture according to an embodiment of the present invention.

### DETAILED DESCRIPTION OF THE DRAWINGS

It will be appreciated that the drawings have been provided for the purposes of illustrating preferred embodiments of the present invention and that the invention should not be considered to be limited solely to the features as shown in the drawings.

According to a preferred embodiment, an improved stabilization means for a watercraft is provided. The preferred embodiment is explained with particular reference to a trailer-borne houseboat.

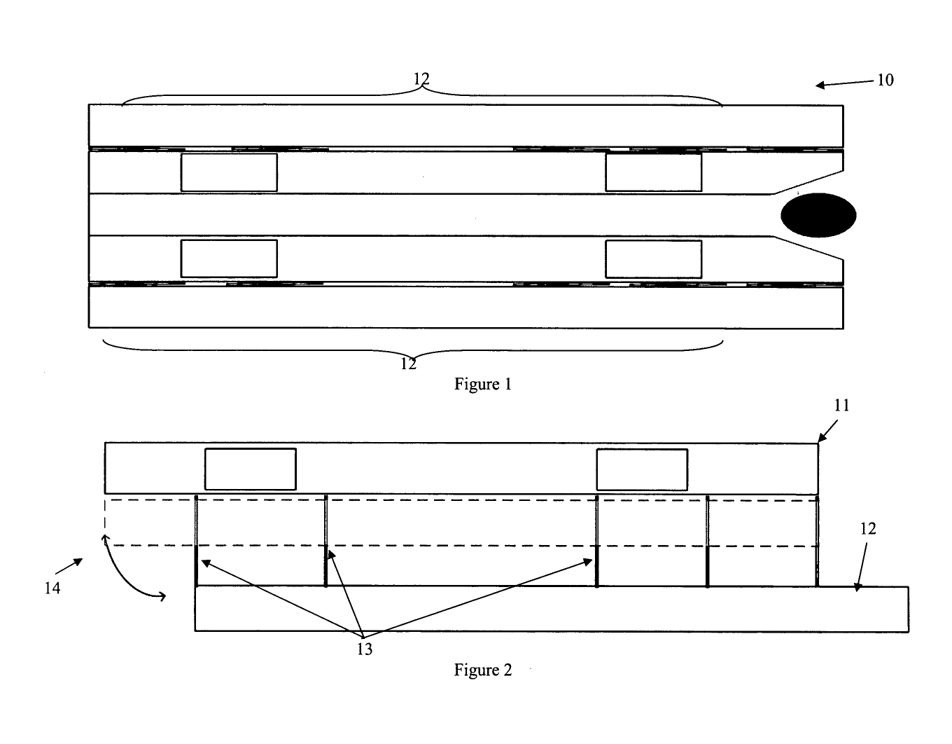

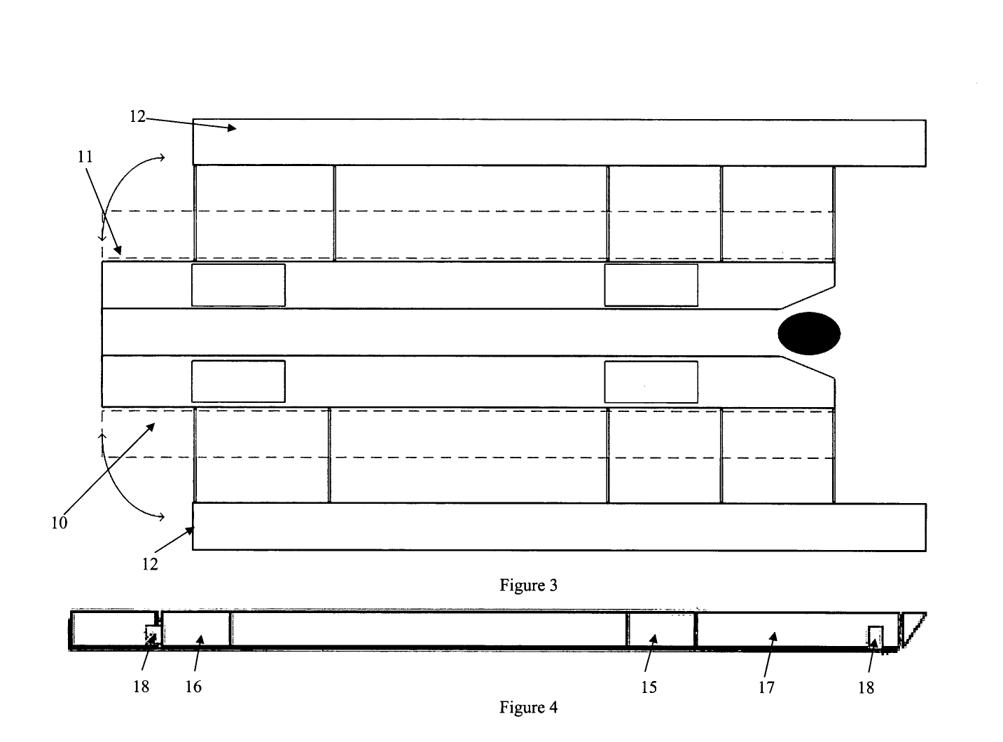

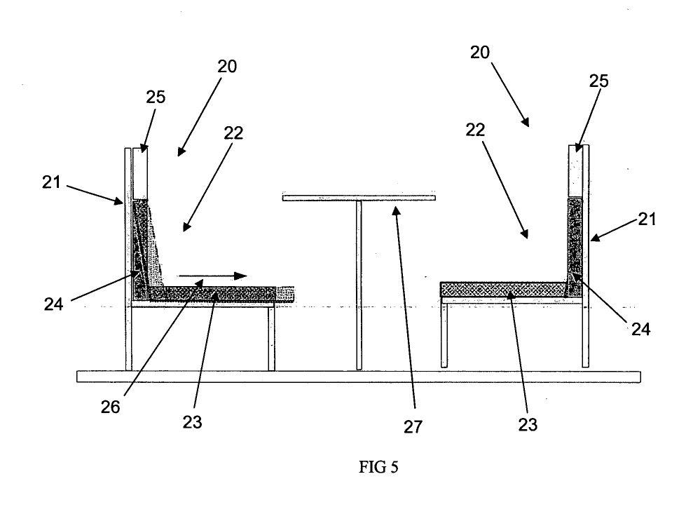

The houseboat 10 has a main hull 11 and a pair of deployable outrigger pontoons 12 each moveable between a stored condition (illustrated in FIG. 1) in which the pontoon 12 is located adjacent the main hull 11, and a use condition (illustrated in FIGS. 2 and 3) in which the pontoon 12 is located spaced from the main hull to increase at least one footprint dimension of the houseboat 10 at the waterline. During deployment the pontoons 12 move outwardly and downwardly.

All other factors being equal, a wider footprint for a watercraft creates a more stable platform. The practical effect of this, particularly when addressing a recreational watercraft such as a houseboat, is that creation of a more stable watercraft results in a more useable and safe watercraft.

The houseboat 10 illustrated is adapted for use as a houseboat when afloat, and when removed from the water and loaded onto a suitable trailer or similar, the houseboat 10 can be used in a manner similar to a conventional caravan.

The main hull 11 is a central or conventional hull which is sufficiently buoyant to support the houseboat 10 without the deployment of the deployable pontoons 12.

The pair of deployable pontoons 12 are provided on opposed lateral sides of the houseboat 10. Each of the pontoons 12 is mounted adjacent the waterline of the houseboat.

The pontoons are attached to the main hull 11 so as to be pivotable or moveable between the stored and use conditions. The pontoons 12 of the illustrated embodiment are attached directly to the main hull 11 using a plurality of arm members 13 attached to both the main hull 11 and the respective pontoon 12.

The pontoons 12 are moveable using any means such as manually, or powered movement. The illustrated embodiment utilised powered movement including hydraulically powered or actuated rams.

Limit stops are provided to prevent movement of the arm members 13 and pontoons 12 outside of the range of the predetermined usage in the form of a cable 14 linking an end portion of a pontoon 12 to the main hull 11 to limit the range of motion.

The arm members 13 can be moved from parallel to a main axis of a hull in the storage condition, to approximately perpendicular to the main axis of a hull 11 in the use condition. Each arm member 13 is at least partially hollow to allow utilities such as power and hydraulics to extend through the arm members 13 between the main hull 11 and the pontoons 12.

The pontoons move both outwardly and downwardly during deployment. Preferably, the deployment of the pontoons moves them to an angle of approximately 5 to 15 degrees of downward angle, and more particularly to between 5 and 10 degrees.

The pontoons 12 of the illustrated embodiment have an elongate, hollow configuration, each pontoon 12 having a number of internal compartments. The majority of the length of each pontoon is typically empty. However, a pair of ballast compartments are provided in the illustrated embodiment, one forward ballast tank 15 and one aft ballast tank 16 in each pontoon 12. The ballast used in the illustrated embodiment is water, and it is preferred that the ballast tanks contain potable water.

A compartment of at least one pontoon is a greywater tank 17 used to store used water for recycling or the like. Pumps 18 are provided to move the ballast water or greywater into and out of the compartments in the pontoons 12.

In FIG. 5 there is shown a pair of reclining seats 20 according to an embodiment of the present invention. Each of the reclining seats 20 comprises a fixed frame 21 and a seating portion 22, the seating portion 22 comprising a base 23 and a back 24. The frame 21 further comprises a headrest 25 which is fixedly attached to the frame 21. The reclining seat 20 shown in the right hand side of the figure is in the upright condition, while the reclining seat 20 shown in the left hand side of the figure has had a force applied to the seating portion 22 in the direction indicated by arrow 26. Once a force has been applied, the base 23 slides forward while the back 24 slides up and down against the stationary frame 21. In this way, a user (not shown) may recline the seat 20 if, for instance, the user wishes to move closer to a table 27. By applying the force, the reclining seat 20 transitions between the upright condition and the reclined condition. It may be clearly seen from this figure that no part of the seating portion 22 moves further rearwardly in the reclined position than when the reclining seat 20 is in the upright condition.

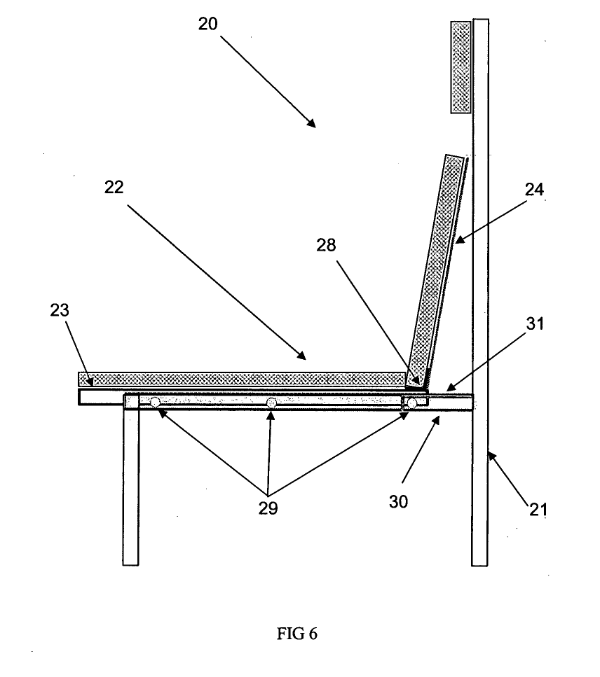

In FIG. 6, a more detailed view of a reclining seat 20 according to an embodiment of the present invention is shown. The base 23 of the seating portion 22 is connected to the back 24 via a hinge 28. Thus, when the base 23 moves towards the front of the frame 21, the hinge 28 causes the back 24 to recline and move down the back of the frame 21.

The base 23 is provided with three pairs of rollers 29 that engage the base 30 of the frame 21 such that when a force is applied to the seating portion 22, the base 23 moves relative to the frame 21 by a rolling action supplied by the rollers 29.

The reclining seat 20 is also provided with a retainer 31 fixedly connected to the frame 21. The retainer 31 is adapted to limit the forward movement of the base 23 by preventing the rearmost pair of rollers 29 from moving beyond the retainer 31. In this way, the seating portion 22 is prevented from rolling forward to such an extent that the seating portion 22 falls off the front of the frame 21.

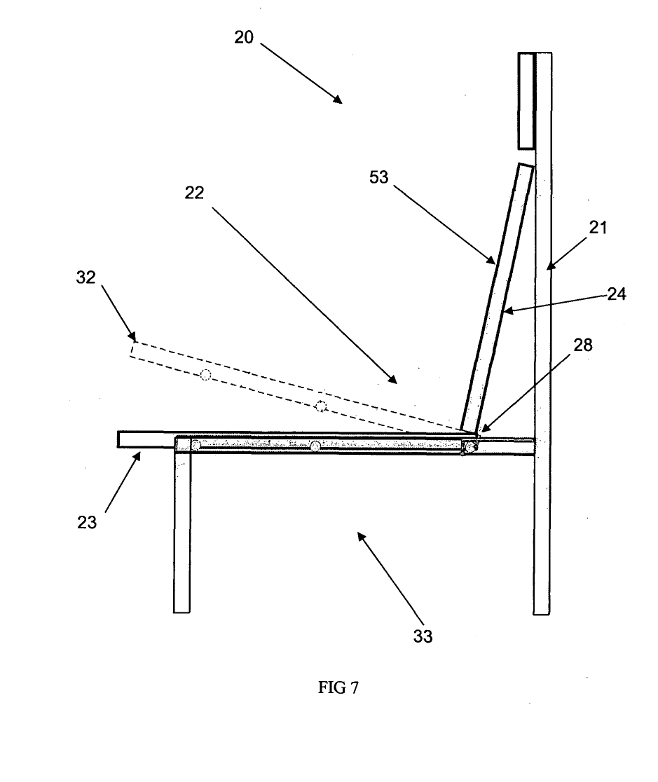

In FIG. 7, an alternative embodiment of the reclining seat 20 of the present invention is shown. In this embodiment, the hinge 28 is provided on the front of the base 23 and the back 24 but behind the layer of cushioning 53 provided on the base 23 and the back 24. When the seating portion 22 is in the fully extended position, as shown in the Figure, the base 23 may be pivoted upwards to the position indicated by the dotted outline 32. The ability to pivot the base 23 allows the user to clean the frame 21 under the base 23, or to gain access to the space 33 under the seat 20.

Turning now to FIG. 8, there is shown a fixture 40 in the form of a sink or basin located next to a toilet 48 in a bathroom. The sink 40 has an inlet 41 through which fluid from a spout 42 (the flow of fluid being controlled by a pair of taps 42a) enters the sink 40 and an outlet 42 through which the fluid exits the sink 40 and enters a waste removal device 43 in the form of a pipe. The inlet 49 of the waste removal device 43 is provided with a cup portion 50 over which the outlet 52 is positioned when the sink 40 is in the first position. In this position, the cup portion 50 will collect all fluid exiting the sink 40 through the outlet 52.

The sink 40 is mounted on a pair of rails 44 which are in turn mounted to the wall 45 of the bathroom. When a force is applied to the sink 40 in the direction indicated by arrow 46, the sink 40 moves relative to the wall 45 by sliding along the rails to a second position indicated by outline 47.

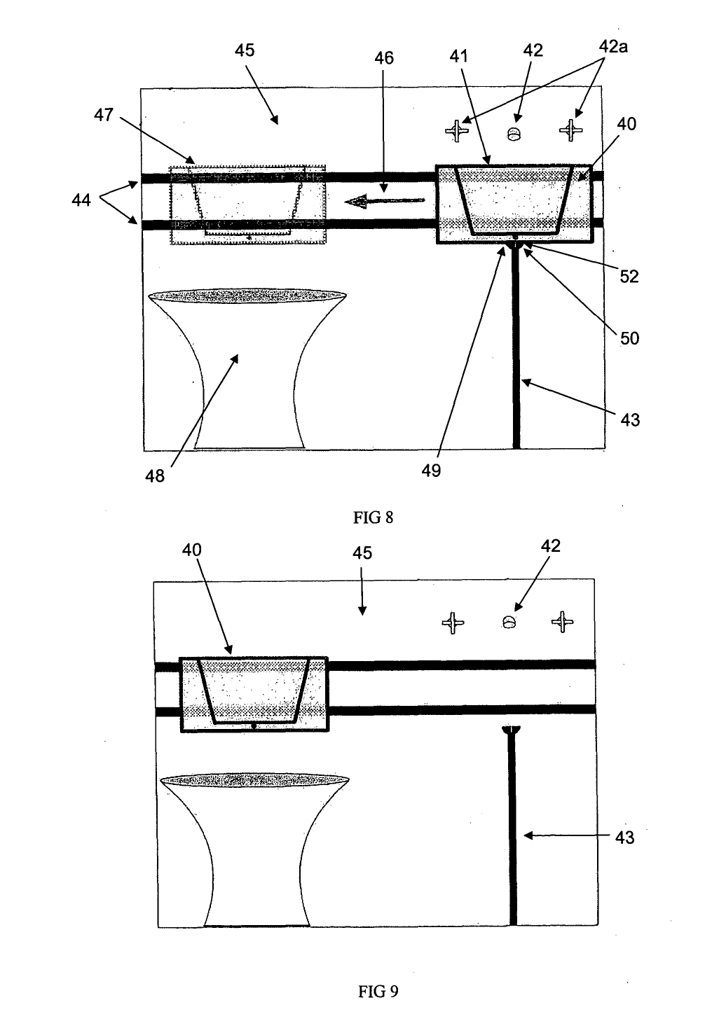

In FIG. 9, the sink 40 is shown when no longer aligned with the waste removal device 43 or the spout 42 (i.e. in its second position). When the sink 40 is in this position, the spout 42 may be swiveled or pivoted so as to rest against the wall 45. In this way, the section of the room where the sink 40 is positioned during normal use becomes vacant and may be used for temporary storage, cleaning or maintenance of plumbing fittings. Alternatively, a shower head (not shown) or similar fitting may be located on the wall 45 at a point above the spout 42. When the sink 40 is moved to the position indicated in FIG. 9, a person may now use the space to have a shower which would not otherwise have been possible if the sink 40 was located in the first position.

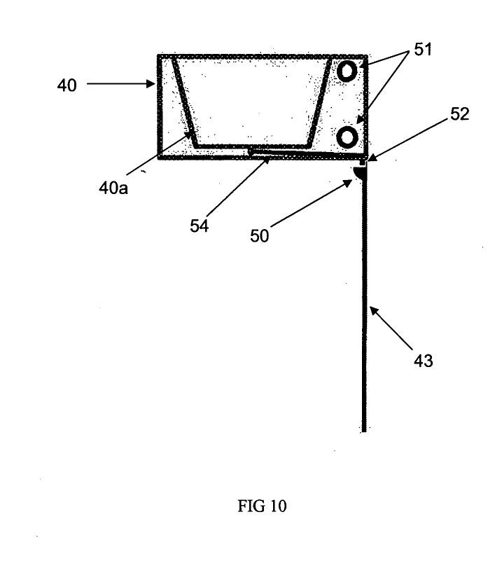

In FIG. 10, a side view of the sink 40 is shown. In this figure it may be clearly seen that the outlet 52 is positioned directly over a cup portion 50 of the waste removal device 43, thereby ensuring that any fluid exiting the sink 40 will be collected by the waste removal device 43 and will not spill or splash over the floor or walls.

The outlet 52 is in fluid communication with the sink 40 via a pipe 54 extending from the centre of the sink bowl 40a to the outlet 52. The pipe 54 slopes downwardly so that fluid flowing through the pipe 54 flows under gravity from the sink bowl 40a to the outlet 52.

It might also be seen in this figure that the sink 40 is provided with a pair of apertures 51 through which the rails (not shown) pass in order to connect the sink 40 to a support.

Those skilled in the art will appreciate that the present invention may be susceptible to variations and modifications other than those specifically described. It will be understood that the present invention encompasses all such variations and modifications that fall within its spirit and scope.

1. A watercraft having a main hull and at least one deployable outrigger pontoon moveable between a stored condition in which the at least one outrigger pontoon is located adjacent the main hull, and a use condition in which the at least one outrigger pontoon is located spaced from the main hull to increase at least one footprint dimension of the watercraft at the waterline, the at least one deployable outrigger pontoon moving at least partially outwardly and downwardly during deployment.

2. A watercraft according to claim 1 wherein the at least one outrigger pontoon is mounted at or adjacent the waterline of the watercraft.

3. A watercraft according to claim 1 wherein a pair of deployable pontoons are provided on opposed lateral sides of the watercraft.

4. A watercraft according to claim 1 wherein the pontoons are attached directly to the main hull.

5. A watercraft according to claim 1 wherein movement of the pontoons is achieved using powered movement.

6. A watercraft according to claim 5 wherein the powered movement of the pontoons is achieved using hydraulically powered or actuated means.

7. A watercraft according to claim 1 wherein the watercraft is an amphibious vehicle.

8. A watercraft according to claim 1 wherein the watercraft is a caravan, houseboat, mobile home or campervan.

9. A reclining seat comprising a frame, a seating portion comprising at least a base and a back, the seating portion being in abutment with the frame and adapted for relative movement thereto, the reclining seat further comprising means to enhance the relative movement of the frame and the seating portion, and wherein no part of the seating portion moves further rearwardly when the reclining seat is in a reclined condition than when the reclining seat is in an upright condition.

10. A reclining seat according to claim 9 wherein the movement of the seating portion relative to the frame is achieved manually or by powered means.

11. A reclining seat according to claim 9 wherein, as the seat transitions between an upright condition and a reclined condition, the base of the seating portion moves in a substantially horizontal direction.

12. A reclining seat according to claim 11 wherein the base moves towards the front of the reclining seat as the seat transitions from the upright condition to the reclined condition.

13. A reclining seat according to claim 11 wherein the angle between the back of the seating portion and the base of the seating portion decreases as the seat transitions between the upright condition and the reclined condition.

14. A reclining seat according to claim 9 wherein the means to enhance the relative movement of the frame and the seating portion comprises one or more rollers, slides, telescoping sections or endless tracks.

15. A reclining seat according to claim 9 further comprising one or more movement limiting devices adapted to prevent movement of the seating portion relative to the frame beyond a pre-determined point.

16. A fixture adapted to be mounted relative to a wall, the fixture having at least one inlet and at least one outlet wherein the at least one outlet is adapted for removable alignment with at least one waste removal device, the fixture further comprising mounting means adapted to allow the fixture to be mounted on, and movable relative to, the wall between a first position in which the at least one outlet of the fixture is substantially in alignment with the at least one waste removal device such that any fluid passes through the at least one outlet enters the at least one waste removal device, and a second position in which the at least one outlet and the at least one waste removal device are not in alignment with one another.

17. A fixture according to claim 16 wherein the fixture is mounted to a wall via a pair of rails.

18. A fixture according to claim 16 wherein the fixture is a sink, basin, toilet, shower, bath or trough.

19. A watercraft according to claim 1, further comprising:
a fixture adapted to be mounted relative to a wall, the fixture having at least one inlet and at least one outlet wherein the at least one outlet is adapted for removable alignment with at least one waste removal device, the fixture further comprising mounting means adapted to allow the fixture to be mounted on, and movable relative to, the wall between a first position in which the at least one outlet of the fixture is substantially in alignment with the at least one waste removal device such that any fluid passes through the at least one outlet enters the at least one waste removal device, and a second position in which the at least one outlet and the at least one waste removal device are not in alignment with one another.

20. A watercraft according to claim 19, further comprising:
a reclining seat comprising a frame, a seating portion comprising at least a base and a back, the seating portion being in abutment with the frame and adapted for relative movement thereto, the reclining seat further comprising means to enhance the relative movement of the frame and the seating portion, and wherein no part of the seating portion moves further rearwardly when the reclining seat is in a reclined condition than when the reclining seat is in an upright condition.
